(19) United States
(12) Patent Application Publication
(10) Pub. No.: US 2021/0267368 A1
(43) Pub. Date: Sep. 2, 2021

(54) Storage Device

(71) Applicant: Moresy GmbH, Berg (DE)

(72) Inventor: Jens Bruins, Berg (DE)

(21) Appl. No.: 16/758,948

(22) PCT Filed: Oct. 26, 2018
(86) PCT No.: PCT/EP2018/079416

§ 371 Date: May 10, 2021

(30) Foreign Application Priority Data
Oct. 26, 2017 (DE) 10 2017 125 121.9

(51) Int. Cl. A47B 87/02; F16B 12/38; B25H 3/02

(52) U.S. Cl. CPC A47B 87/0292; A47B 2230/07; B25H 3/021; F16B 12/38

(57) ABSTRACT

The invention relates to a storage device (1000) having: a cube-like housing (100) having an interior (101) having: a front side (100a) for the insertion and withdrawal of objects in and out of the interior (101), and at least one first opening in an outer side of the housing (100) for receiving respectively one positioning element (110), wherein, in a state in which the positioning element (110) is inserted into the first opening, a movement of the housing (100) relative to the positioning element (110) is prevented; at least one second opening in an outer side of the housing (100) for receiving respectively one locking element (130), wherein the storage device (1000) also has: a locking device (130) for locking the housing (100) to the locking element (130) in a state in which the locking element (130) is inserted into the second opening, and an unlocking device (150) on an outer side of the housing (100) for detaching the housing (100) from the locking element (130)

This invention relates to a storage device, in particular to a storage device that can easily be combined, connected with or locked to another or similar storage device.

### BACKGROUND

In general, storage devices, such as tool cases, tool cabinets, briefcases, filing cabinets, document cases, document cabinets, and so on, have the problem that when they are placed side by side or stacked on top of each other, they cannot be connected to each other. In other words, several such storage devices, when placed side by side, are not fixed or locked together. This is particularly a problem because they often contain heavy objects such as stacks of documents, tools, spare parts, samples, furniture parts, files and so on. If the storage devices tip over, this can lead to serious injuries and damage.

In addition, the problem of tipping over occurs in particular when one or more of the above-mentioned storage devices are standing or transported in vehicles, such as cars, vans, trucks and so on. Vibrations while driving, sudden braking or sudden changes of direction may, due to the inertia of the storage devices with their contents, exert forces that cause the storage devices to tilt or tip over, with the consequences described above.

It is therefore an object of the invention to provide a storage device preventing or solving the issues mentioned above.

In particular, it is an object of the invention to provide a storage device preventing tipping over of the storage device. A further object is to provide the possibility to enable a modular extension of the storage device with one or more other storage devices.

Furthermore, it is an object of the invention to provide a storage device which is secured against tilting or tipping over by adjacent, adjoining and identical or similar storage devices.

Furthermore, it is an object of the invention to provide a storage device which can be securely placed on another, identical or similar storage device.

Moreover, it is an object of the invention to provide a storage device which can be quickly and easily secured against tipping over and can be released again.

The object is solved by the features of the independent claim. Other advantageous embodiments and designs are subject of dependent claims.

According to an embodiment, a storage device is provided, comprising: a cuboid housing with an inner space, comprising: a front side for inserting and removing objects into and out of the inner space, and at least one first opening on one side of the storage device for receiving a respective positioning element, wherein in a state in which the positioning element is inserted into the first opening movement of the housing relative to the positioning element is prevented; at least a second opening on another side of the storage device for receiving a locking element, wherein the storage device further comprises: at least a locking device for locking the storage device on the at least locking element in a state in which the locking element is inserted into the second opening and at least one unlocking device on an outside of the housing for releasing the housing from the locking element. According to an embodiment, the first opening and/or the second opening may be formed in an outside of the housing.

The storage device can be configured as office furniture, file shelf, file stand, briefcase, filing cabinet, storage box for the office and workshop area, portable container, office cabinet, office container, side trolley, forms cabinet, suspension file trolley, brochure cabinet, mobile or modular filing system, filing case, filing cabinet, drawer cabinet, card index cabinet, tool cabinet, tool box, container for small parts and tools, tool and assortment box, cabinet or case, modular storage system, rolling container, stackable container; combinable container, portable container, portable assortment system, storage system for documents, document case or document cabinet

The storage device can be made of metal, precious metals, aluminum, stainless steel, plastic, paper, cardboard, corrugated cardboard, a paper composite or wood, or a mixture thereof.

According to one embodiment, the storage device is a transportable or mobile storage device. The storage device is particularly preferred to be portable by one user. For this purpose, the storage device can have one or more handles or similar.

Preferably, the storage device has at least one locking element on a side wall of the housing, wherein the at least one locking element protrudes from the housing and is located at a position which corresponds to the position of a second opening at a side of the storage device being opposite to the side wall. According to one embodiment, the second opening is located on a side wall of the housing.

I.e., in a state in which the at least one locking element of a first storage device is inserted into the positionally corresponding second opening of a second storage device, the two storage devices are located directly next to each other and fixed to each other.

Especially preferably, the two storage devices are located flush or in alignment next to each other. Preferably the storage device has two openings on one side wall and also has two locking elements on the opposite side wall at positions corresponding to the two openings on the one side wall.

Thus, when two such storage devices are placed side by side or located side by side, the locking elements of the one storage device protruding from the housing are simultaneously inserted into the corresponding second openings provided in the housing of the second storage device. A locking element in or on the second storage device fixes or blocks the locking elements of the first storage device in the respective second openings of the second storage device. This prevents the locking elements from being released from the openings. As a result, the two storage devices are attached or fixed to each other and support each other. In other words, movement of the two storage devices relative to each other is prevented or restricted. Tilting or tipping over or movement of one of the two storage devices is prevented by the respective other storage device.

Preferably, the storage device further comprises at least one positioning element on an upper side or a lower side of the housing, wherein the at least one positioning element protrudes from the housing and is located at a position which corresponds to the position of a first opening at one opposite side of the upper side or lower side of the storage device. According to an embodiment, the first opening is located on a upper side or a lower side of the housing.

I.e. in a state in which the at least one positioning element of a first storage device is inserted into the first opening of a second storage device, the second storage device is directly located on or below the first storage device.

Preferably, the second storage device is flush on or below the first storage device, i.e. the footprints of both storage devices are identical.

Therefore, when two such storage devices are placed on top of each other or located one above the other, the positioning elements of the first (lower or upper) storage device protruding from the housing on the lower side or upper side are simultaneously inserted into the corresponding first openings provided on the lower side or the upper side of the second (upper or lower) storage device. This prevents or restricts movement of the two storage devices relative to each other. In other words, the second storage device, which is located on top of the first storage device, cannot slide back and forth. In particular, horizontal movement of the upper, second storage device is prevented by the lower storage device.

According to an embodiment, the at least one positioning element is designed at least similar in shape to a locking element. In this case, a locking device is also designed to lock the positioning element to the housing in the same way as the locking element in a state in which the positioning element is inserted into the first opening. Accordingly, an unlocking device is also designed to release the housing from the positioning element.

According to a preferred embodiment, the locking device comprises a first locking device and a second locking device, and/or the unlocking device comprises a first unlocking device and a second unlocking device. The first locking device can be designed to lock the storage device to the at least one positioning element and the first unlocking device can be designed to release the storage device from the at least one positioning element. Accordingly, the second locking device can be designed to lock the storage device to the at least one locking element in accordance with the embodiments described above and the second unlocking device can be designed to release the storage device from the at least one locking element in accordance with the embodiments described above.

Preferably, the at least one locking element and/or the at least one positioning element for locking each has a recess or protrusion interacting with the first and/or second locking device.

This ensures that the locking element and/or the positioning element can be locked or blocked by the locking device particularly easily by form fit.

The positioning element(s) may also have a recess or protrusion for additional locking which interacts with the locking device. This prevents the storage devices that are placed next to each other from moving away from each other.

Depending on the design, the positioning elements, which are preferably located on the upper sides or lower sides of the storage devices, as well as the locking elements, which project laterally from one storage device and engage in the second openings of the adjacent storage device, can be locked.

Preferably, the first locking device is configured to automatically lock the positioning element in the first opening, when the positioning element is inserted into the first opening, so that the positioning element is blocked in the first opening or locked to the housing or the storage device, and wherein the first unlocking device is configured to drive the first locking device when actuated so that the first locking device releases the at least one positioning element. In the case of a plurality of positioning elements, these can be locked together, in other words be locked simultaneously, by the first locking device when they are introduced into the respective first openings and can be released together by means of the first unlocking device when the latter is actuated.

Correspondingly, the second locking device is configured so that when the locking element is inserted into the second opening, the second locking device automatically locks the locking element in the second opening so that the locking element is blocked in the second opening or locked to the housing or storage device. The second unlocking device is configured to drive the second locking device when actuated so that the second locking device releases the at least one locking element. In the case of a plurality of locking elements, these can be locked together, in other words be locked simultaneously, by the second locking device when they are inserted into the respective second openings and can be released together by means of the second unlocking device when the latter is actuated.

This means that two storage devices are automatically locked or attached to each other without further action of a user when they are placed side by side or on top of each other. This means that the storage devices are simply coupled and secured together. Unlocking by the unlocking device, i.e. releasing the at least one locking element or the at least one positioning element, in turn requires an action by the user, so that the user is made aware that the storage devices are no longer locked or are unlocked to each other.

Preferably, the unlocking device has a handle, whereby the unlocking device is actuated by moving the handle. This makes the unlocking device particularly easy to be operated by the user.

Especially preferably, the unlocking device or the first unlocking device and/or the second unlocking device is designed as one push button each.

Preferably, the first unlocking device is mechanically coupled to the first locking device for unlocking the at least one locking element or the plurality of locking elements and the second unlocking device is mechanically coupled to the second locking device for releasing the locking of the at least one locking element or the plurality of locking elements.

In accordance with a particularly preferred embodiment, the first unlocking device is located on a different outside of the storage device than the side or outside on which the at least one first opening is located. For example, the first opening, preferably two first openings, is located on a lower side of the storage device and the unlocking device is located on a rear or front side of the storage device. Accordingly, the second unlocking device is located on a different outside of the storage device than the side, outside or side wall on which the at least one second opening is located. For example, the second opening is located on a side wall or side surface of the storage device and the release device is located on a top or bottom side. This makes the unlocking device easily accessible from the outside and makes it easy to release the locking device.

Further preferably the at least one positioning element and/or the at least one locking element is embodied as a bolt, pin or hook.

Especially preferably, the at least one positioning element and/or the at least one locking element is immersible in the housing, preferably by pressure. In this way, when not in use or not required, for example when only a single storage device is used, the positioning elements and/or the locking elements can be recessed in the housing to counteract damage or to minimize the space required for the storage device.

Further preferably the at least one positioning element and/or the at least one locking element is brought by means of a release device from the state in which the positioning element and/or the locking element is recessed in the housing into the state in which the positioning element and/or the locking element protrudes from the housing. The release device is preferably located in or on the housing. By means of the release device, all positioning and/or locking elements of a storage device can thus be quickly and easily brought centrally back into the unfolded or protruding state. The release device is preferably driven by actuating the unlocking device.

The release device is therefore preferably coupled with the unlocking device. Thus, on the one hand the unlocking device can release or unlock the locking elements in the second openings and on the other hand operate the positioning elements or locking elements.

Preferably, the unlocking device is recessed or retractable in the housing or is flush with the surface of the storage device. Further preferably the locking device is completely located in the housing. Preferably, the release device is completely located in the housing.

This ensures that the unlocking device, the locking device and the release device do not increase the external dimensions of the storage device and they are also protected against external influences such as dust, dirt, moisture and so on and against damage.

Preferably, at least a part of the locking device protrudes into the second opening at least in the state in which the locking element is inserted into the second opening. In the case of a common locking device, this device projects into the several second openings into which the several locking elements are inserted.

Preferably, the storage device has at least one drawer that is designed to be pushed in and pulled out over the front of the housing.

Further preferably, the storage device has at least one door to close the front of the housing. A combination of one or more doors and one or more drawers is also possible.

Further preferably, the storage device has wheels, so that the storage device can be rolled on a underground.

Preferably, the wheels protrude from the housing or are mounted on the outside, i.e. on an outside, e.g. an lower side of the housing.

It is particularly preferable if the release device is configured in such a way that the wheels are recessed into the housing when activated.

The unlocking device can therefore also be used to recede the wheels into the housing or to bring them back into a protruding position in order to use them for the rolling of the storage device.

According to a further embodiment, a storage system comprises at least two storage devices, wherein in an assembled state of the storage system the at least two storage devices are located in such a way that at least one of the locking elements of a first storage device of the two storage devices is inserted and blocked in the corresponding second opening of a second storage device of the two storage devices so that the at least two storage devices are locked to each other.

Preferably the at least two storage devices are located directly next to each other in the assembled state. Preferably, the side dimensions of the adjacent side walls of the two storage devices are the same.

It is particularly preferred if the at least two storage devices are flush when assembled.

The storage devices can therefore have the same outer dimensions. The side surfaces of the housings of the two storage devices can therefore have the same size. Furthermore, the storage devices can have the same base area.

The storage devices need not have a cuboid housing as long as the positioning and locking elements of one of the at least two storage devices correspond in position and size to the first and second openings of another of the at least two storage devices, respectively, so that at least two storage devices can be locked or connected to each other.

### SHORT DESCRIPTION OF THE FIGURES

In the following, embodiments of the present invention are described in detail by means of figures.

FIGS. 1a to 1e show a storage device according to a first embodiment;

FIG. 2 shows a storage device according to a second embodiment;

FIG. 3 shows a storage device according to a third embodiment;

FIG. 4 shows a storage system according to another embodiment in a side-by-side state;

FIGS. 5a to 5c show a storage system according to yet another embodiment in a state of being located side by side and on top of each other;

FIGS. 6a to 6c show a base for a storage device according to an embodiment;

FIG. 7 shows a base for a storage device according to a further embodiment;

FIG. 8 shows a storage device according to an embodiment;

FIGS. 9a to 9c show storage devices according to embodiments; and

FIGS. 10a and 10b show locking elements and positioning elements according to embodiments.

In all figures the same reference signs denote the same or corresponding elements or components. Expressions such as “first”, “second” and “third” are only used to distinguish identical or corresponding elements and do not specify the order or arrangement of the elements among each other.

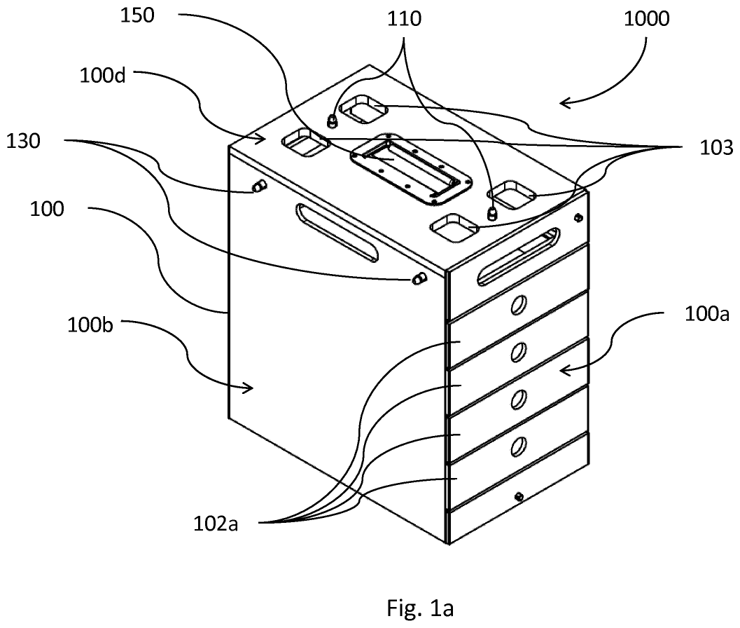

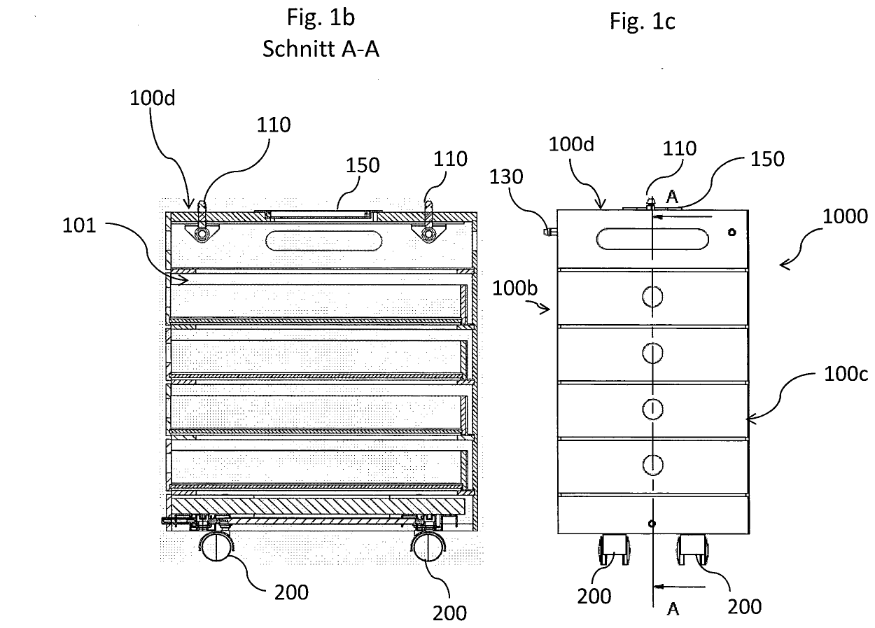

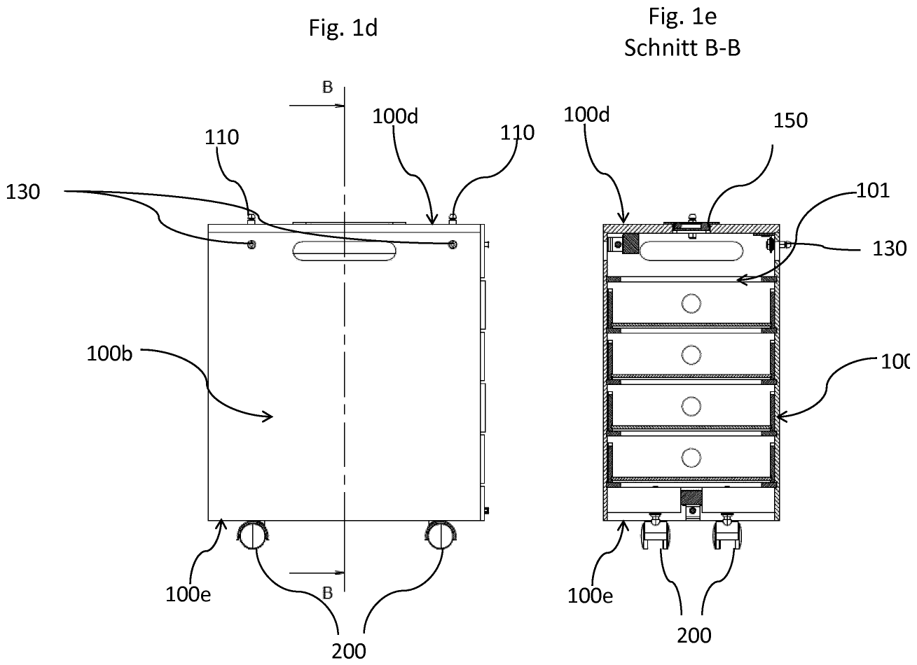

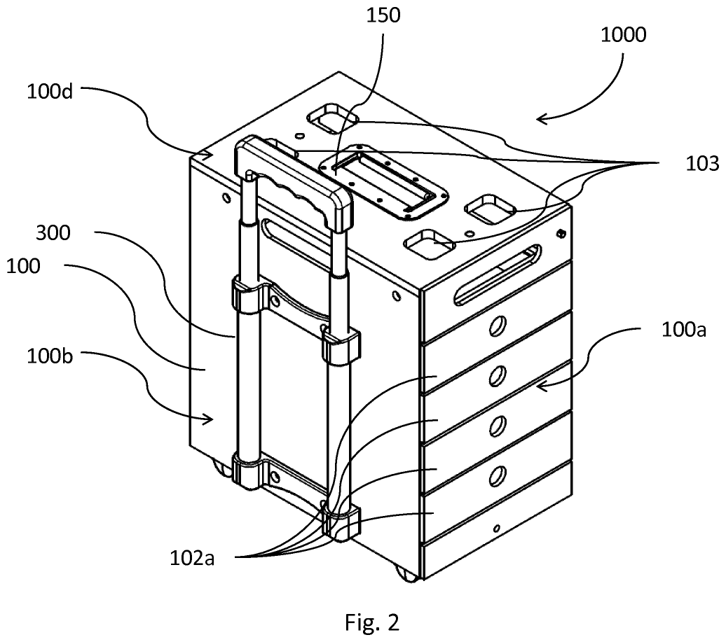

FIGS. 1a to 1e show a storage device according to a first embodiment. In detail, FIG. 1a shows the storage device according to the first embodiment in a perspective view. FIG. 1c shows the storage device in a front view. FIG. 1b shows a sectional view of the storage device along the line A-A in FIG. 1c. FIG. 1d shows the storage device in a side view. FIG. 1e shows a sectional view of the storage device along line B-B in FIG. 1d.

Thus, in FIGS. 1a to 1e a storage device 1000 is shown. The storage device has an essentially cuboid housing 100. The housing has an inner space 101. The inner space 101 is intended for storing objects (not shown). The items may include documents, paper, files, tools, books, assembly materials, material samples, decoration materials, craft materials, and so on.

The housing 100 has a front side 100a, through which the inner space 101 is accessible. In other words, the front side 100a is used to enter or insert objects into the inner space 101 and to take them out or remove them again. According to another embodiment, the inner space 101 can also be accessible via another outside of the housing 100.

The housing 100 also has side surfaces or side walls 100b, 100c. More precisely, the housing 100 has a left side surface 100b and a right side surface 100c. The housing also has an upper side 100d and a lower side 100e.

According to the embodiment shown in the FIGS. 1a to 1e, the storage device 1000 has one or more drawers 102a. The inner space 101 can be divided up by the drawers 102a. This allows the objects stored or kept in it to be sorted or located or classified. The drawers 102a are inserted into the inner space 101 via the front side 100a and can be pulled out or pushed in again via the front side 100a.

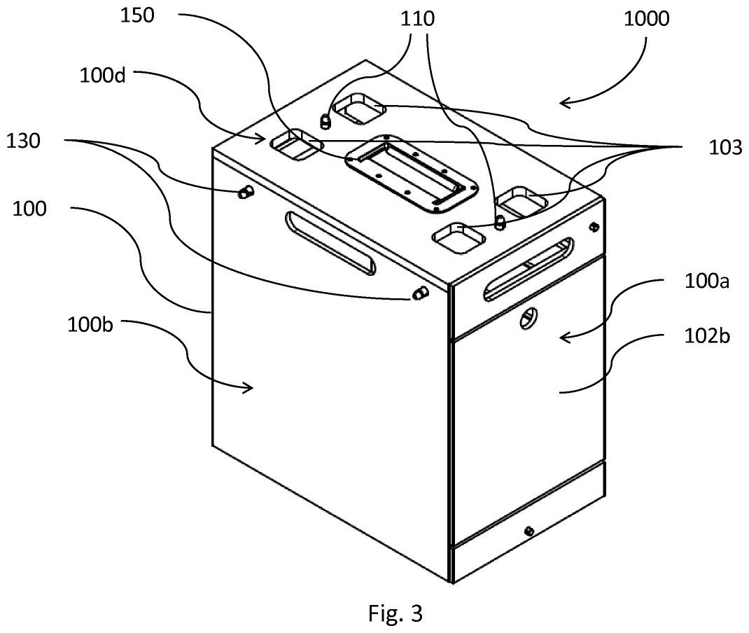

According to the embodiment shown in FIG. 3, the storage device 1000 has additionally or alternatively a door 102b at the front side 100a of the housing 100. The door 102b is used to lock and open the inner space 101 of the housing 100. The door 102b may also have a lock (not shown).

The storage device 1000 also has at least one positioning element 110. In the embodiment shown in FIGS. 1a to 1e, the storage device 1000 has two positioning elements 110. The positioning elements are located on an outside of the housing 100. More precisely, the positioning elements 110 are located on the upper side 100d and protrude from the upper side 100d.

The storage device 1000 also has at least one first opening (not shown). The first opening is located on one side of the storage device.

According to an embodiment, the first opening is located on an outside of the housing 100. More precisely, the first opening is located on an outside of the housing 100 opposite to the outside where the positioning elements 110 are located. More precisely, the at least one first opening is located on the lower side 100e of the housing 100 (not shown).

The first openings serve to accommodate the positioning elements 110 of another storage device 1000, which is located or stacked on the shown storage device 1000. The first openings are thus designed in such a way that they are suitable for receiving the positioning elements 110. Ideally, the first openings are slightly larger than the cross-section of the positioning elements 110 and completely accommodate the positioning elements 110. It is thereby achieved that the two storage devices 1000 can be located flat on top of each another.

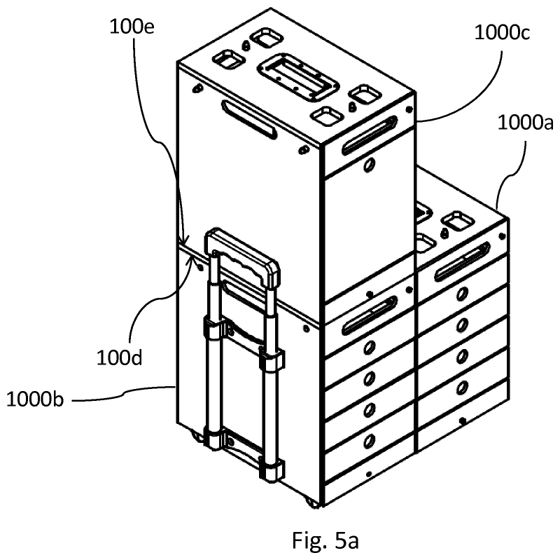

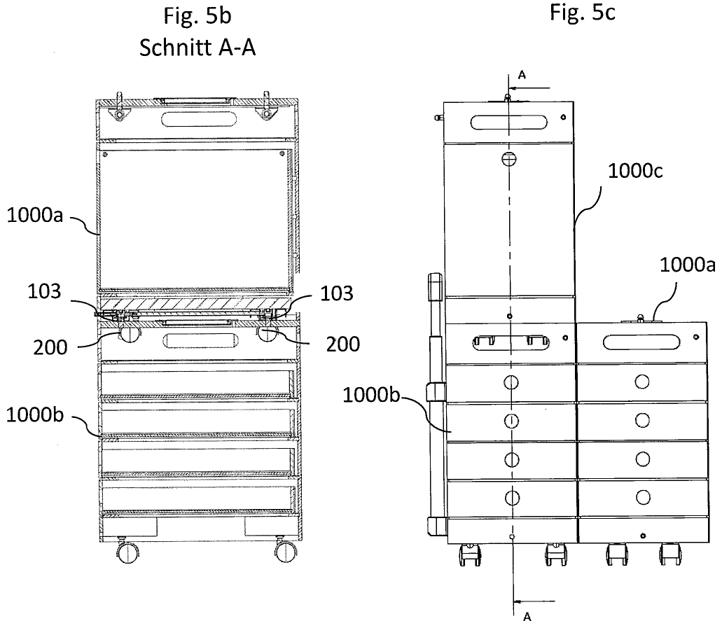

This arrangement is illustrated in FIGS. 5a to 5c. FIGS. 5a to 5c show a storage system according to an embodiment, which has, among other things, two storage devices 1000b, and 1000c. The lower side 100e of the upper storage device 1000c lies flat or completely on the upper side 100d of the lower storage device 1000b.

The position of a first opening on the lower side 100e thus corresponds to a position of a positioning element 110 on the upper side 100d. If the storage device 1000 has several positioning elements 110, these must be located in such a way that all positioning elements 110 are completely inserted into the first openings when the storage devices 1000b, 1000c are located or stacked on top of each other.

In the state in which at least one positioning element 110 of the storage device 1000b located below is inserted into one of the first openings of the storage device 1000c located above, movement of the housing 100 of the storage device 1000c located above relative to the positioning element 110 of the storage device located below 1000b is prevented. In other words, movement of the two storage devices 1000c, 1000b relative to each other is prevented. This stops the storage device 1000c located above from slipping or falling off the storage device 1000b located below. The storage device 1000c located above is thus located directly on the storage device 1000b located below. According to other embodiments, the housings of the two storage devices 1000 can be located flush.

Alternatively, the positioning elements 110 and the first openings can also be located interchanged, i.e. the positioning elements 110 can be located on the lower side 100e and the first openings can be located on the upper side 100d. The positioning elements 110 and the first openings can also be located on the side surfaces 100b, 100c.

The storage device 1000 also has at least one locking element 130. In the embodiment shown in FIGS. 1a to 1c, the storage device 1000 has two locking elements 130. The locking elements are located on the outside of the housing 100. Specifically, the locking elements are located on the left and/or right side surface 100b and protrude from the side surface 100b. The locking elements 130 can be located horizontally next to each other, as shown in FIG. 1a to 1e.

The storage device 1000 also has at least one second opening (not shown). The second opening is located on one side of the storage device.

According to one embodiment, the second openings are located on an outside of the housing 100. More specifically, the second opening is located on an outside of the housing 100, which is opposite to the outside on which the locking elements 130 are located. More specifically, the at least one second opening is located on the right and/or left side surface 100c of the housing (not shown).

The preferably two second openings serve to receive the preferably two locking elements 130 of a further, second storage device 1000, which is located or lined up or standing on the left or right of the storage device 1000. The second openings are thus designed so that they are suitable for receiving the locking elements 130. Ideally, the second openings are slightly larger than the cross section of the locking device 130 and receive the locking elements 130 completely. It is thereby achieved that the two storage devices 1000 can be located flat next to each other.

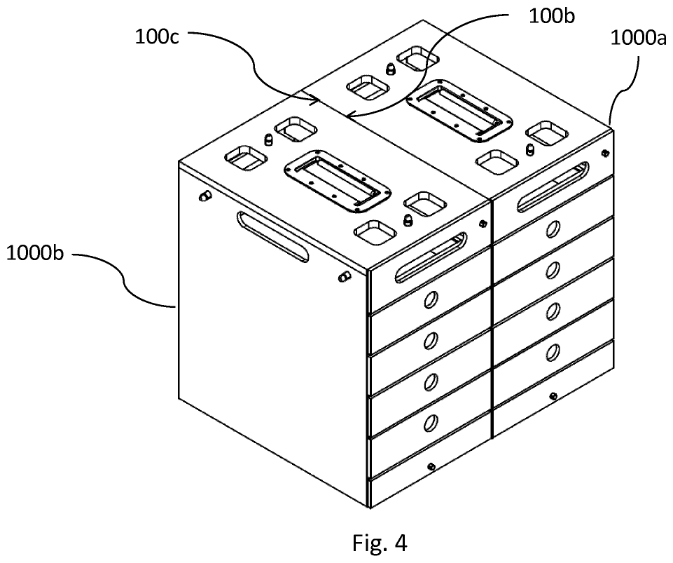

This arrangement is illustrated in FIG. 4. FIG. 4 shows a storage system according to an embodiment, which has two storage devices 1000a, 1000b. The right side surface 100c of the left storage device 1000b lies flat or completely on the left side surface 100b of the right storage device 1000a. The arrangement is also illustrated in FIG. 5a.

The position of a second opening on the right side surface 100c thus corresponds to a position of a locking element 130 on the left side surface 100b. If the storage device 1000 has a plurality locking elements 130, the plurality of second openings must be located in such a way that all locking elements 130 are completely inserted into the second openings when the storage devices 1000a, 1000b are located next to each other.

The storage device 1000 also has a locking device (not shown). The locking device serves to lock or block the housing 100 of the left-hand storage device 1000b to the at least one locking element 130 of the right-hand storage device 1000a when the at least one locking element 130 of the right-hand storage device 1000b is inserted into the corresponding, assigned second opening of the left-hand storage device 1000a. The at least one locking element 130 of the storage device 1000a located on the right is, for example, inserted into the corresponding, assigned second opening of the storage device 1000b located on the left when the two storage devices 1000a, 1000b are located next to each other. In this state, in which the at least one locking element 130 of the storage device located on the right 1000a is inserted into the corresponding assigned second opening of the storage device 1000b located on the left, the locking device locks the at least one locking element 130 to the housing 100. This prevents the two storage devices 1000a, 1000b from moving away from each other, without the user requesting this. The two storage devices are thus firmly connected to each other. Movement or tilting of the one storage device 1000a, 1000b is thus prevented by the connection or locking to the other storage device 1000a, 1000b.

The locking or fixing of the locking element 130 by the locking device can be carried out automatically when the locking element 130 is inserted into the second opening. Alternatively, the locking element 130 can be inserted into the second opening and then the user actuates the locking device so that the locking is only then carried out.

The locking element 130 preferably has a notch or a at least partially circumferential groove, these being designed so that the locking device when locking, i.e. during snapping into the notch or the at least partially circumferential groove, pulls the locking element 130 further into the second opening. For this purpose, the locking element 130 can have an inclined surface, which is first inserted into the second opening when the locking element 130 is inserted into the second opening and on which the locking device, e.g. hooks or clamping pliers engage and slide along and thereby pull the locking element 130 further into the second opening until the locking device engages completely in the notch or groove and thus the second storage device 1000b is firmly held on the first storage device 1000a.

In addition, it may be provided that corresponding projections and notches are located on the adjoining side surfaces of the two storage devices 1000a, 1000b in an assembled state, which offer an additional hold against displacement of the two storage devices 1000a, 1000b in the assembled state. These can be, for example, cuboid or angled cuboid projections that are inserted into corresponding notches of the opposite storage device. Unlike the locked locking elements 130, these do not offer any hold with respect to a movement of the two storage devices 1000a, 1000b away from each other, but can prevent a shearing movement of the two storage devices 1000a, 1000b and thus absorb a large part of the forces, that occur with two storage devices 1000a, 1000b placed side by side so that the locking device does not have to absorb all forces. An analogue device can be provided for the positioning elements 110. That is, by simple form fit connections, for example by protrusions on one storage device and corresponding indentations on the other storage device, the forces on the locking device can be reduced and thus the dimensioning of the locking device can be reduced.

The locking of the locking element 130 can be take place, for example, by frictional engagement between the locking element 130 and the locking device and/or the housing 100. As an alternative or in addition, the locking can take place by form fit between the locking element 130 and the locking device and/or the housing 100. For this purpose, according to one embodiment, the locking element 130 is designed as a bolt or pin and furthermore has a protrusion, an annular groove or a depression, which interacts with a corresponding depression or a corresponding protrusion of the locking device or the housing 100.

In addition, the locking device can also be plier- or scissors-shaped. In this case, the locking device can be provided in the second opening so that it opens when a locking element is inserted into the second opening. Then the at least one gripping jaw of the pliers engages, for example by spring force, in a corresponding groove or recess in the locking element, so that the locking element is held in the second opening and is thereby blocked. The one or more gripping jaws of the plier-shaped locking device are thus held by spring force from a spring element in a corresponding groove or recess, whereby a form fit or frictional connection occurs, which carries out the locking of the locking element. In this case, the locking can be released by a force acting on the locking element that overcomes the spring force of the spring element.

Alternatively, the locking device can also be designed as a bolt, pin or hook, which interacts with a corresponding eyelet, a corresponding recess or a corresponding protrusion of the locking device or the housing 100. The positioning element can also be designed as a pin, bolt or hook.

The storage device 1000 also has an unlocking device 150. According to the embodiment of FIG. 1a to 1e, the unlocking device 150 is located on the upper side 100d of the housing 100. However, the unlocking device 150 is not limited to this. The unlocking device can be located at any position 150 on or in the housing 100, or in the inner space 101 of the housing 100, which is accessible to the user.

The unlocking device 150 is thus located on another outside of the housing 100 than the locking elements 130 and the second openings. This has the advantage that the unlocking device 150 is accessible to a user even in a state when two storage devices stand against each other and are locked to each other.

The locking of the locking element 130 in the second opening of the housing 100 can be released again by means of the unlocking device 150. That is, the unlocking device 150 is connected to the locking device. The connection can be mechanical or electrical. The unlocking device 150 can be a button or a switch or a similar control element, which causes a manual actuation of the locking device or sends an electrical signal to the locking device. By means of the connection between the unlocking device 150 and the locking device, the locking device can also be actuated or activated and driven when the unlocking device 150 is actuated, so that the locking device releases the locking element 130 again and thereby releases the locking or the blocking of the locking element 130. The user can thus consciously and intentionally operate the unlocking device if he wishes to separate the two storage devices 1000 again or move them away from each other.

According to one embodiment, the unlocking device 150 and the locking device are realized by a single device.

According to one embodiment, the connection between the unlocking device 150 and the locking device is similar to a locking system of a trunk of a vehicle. This means that the unlocking device corresponds to the handle or push button for opening the lock of the trunk. The connection between the unlocking device and the locking device can accordingly be designed mechanically, for example as a linkage, cable pull or Bowden cable.

According to an embodiment, the unlocking device 150 has a handle or push-button and the unlocking device 150 is operated by the user pulling or turning the handle or pushing the push-button.

The storage device 1000b located on the left is therefore located directly next to the storage device 1000a located on the right. According to other embodiments, the housings of the two storage devices 1000a, 1000b can additionally be located flush.

Alternatively, the locking elements 130 and the second openings can also be located reversed, i.e. the locking elements 130 can be located on the right side surface 100c and the second openings can be located on the left side surface 100b. The locking elements 130 and the second openings can be located additionally or alternatively on the upper side 100d and/or the lower side 100e.

According to the embodiment shown, the positioning elements 110 and the locking elements 130 protrude from the housing 100. In other words, the positioning elements 110 and the locking elements 130 protrude from the outside of the housing 100. According to another embodiment, the positioning elements 110 and/or the locking elements 130 are designed in such a way that they can be retracted into the housing 100. The positioning elements 110 and/or the locking elements 130 can, for example, be retracted into the housing 100 by pressure or by pushing. Pressing the positioning elements 110 and/or the locking elements 130 again may cause the positioning elements 110 and/or the locking elements 130 to be moved from the recessed position to the protruding position. This mechanism can be realized by means of a spring element and a catching element. Alternatively, the positioning elements 110 and/or the locking elements 130 can be folded back and forth between the two positions.

In addition, the storage device 1000 can have a release device (not shown). By means of the release device it is possible to move the positioning elements 110 and/or the locking elements 130 from the retracted or folded state to the protruding state. The release device can be located inside the housing 100 not visible to the user and can be operated in the same way as the locking device via the unlocking device 150. For example, turning the handle of the unlocking device 150 in one direction may actuate the locking device, and turning the handle in the opposite direction may actuate the release device. Alternatively, turning the handle may actuate the locking device and further turning the handle in the same direction may actuate the release device.

According to an embodiment, the locking device and/or the release device are located within the housing 100. More precisely, the unlocking device 150, the locking device and/or the release device are located entirely inside the housing 100 in the space between the outside of the housing and the inner space 101 of the housing 100, so that they are not visible or accessible to the user. They are thus protected from external influences such as mechanical stress, dust, dirt and moisture. Furthermore, this does not increase the space requirement or the volume of the storage device 100. The unlocking device 150 can be recessed or formed to be immersible flush with an outside of the housing 100, wherein the unlocking device 150 is simultaneously accessible to a user from the outside.

As shown in FIGS. 1b to 1e, the storage device 1000 also has one or more wheels 200. For example, the storage device 1000 may have three or more wheels 200. The wheels 200 are preferably attached to the lower side 100e or protrude from the lower side 100e. The wheels can be used to roll the storage device 1000 on an underground. The storage device 1000 can, for example, be pulled by a user and thereby roll. Alternatively, the storage device 1000 can also have rails, sliding elements or similar to be moved.

In order for the upper side 100d and the lower side 100e of two storage devices 1000, which are placed one above each other, to be in direct contact with each other despite the wheels 200, the upper side 100d of the storage device 1000 placed below can have corresponding wheel receptacles 103 in which the wheels 200 are inserted. The wheel receptacles 103 can be formed as openings in the upper side 100d of the storage device 100 located below. By means of the wheel receptacles 103, the wheels 200 of the upper storage device 1000 are inserted into the housing 1000 of the lower storage device when the two storage devices 1000 are located one on top of the other. FIG. 5b shows the state in which the wheels 200 of the upper storage device 1000c are inserted into the wheel receptacles 103 of the lower storage device 1000b so that the lower side 100e of the upper storage device 1000c is directly in contact with the upper side 100d of the lower storage device 1000b. The wheel receptacles can be closed with flaps when not in use. The flaps are pushed away when the wheels are inserted.

The unlocking device 150 can also be designed in such a way that the wheels 200 are also lowered into the housing 100 when operated. In this way, the storage device 1000 can also be placed directly on an underground without rolling away unintentionally.

FIG. 2 shows a storage device according to a second embodiment. The embodiment of the storage device 1000 shown in FIG. 2 is the same as the embodiment shown in FIGS. 1a to 1e, with the difference that the second embodiment has also a guide handle 300.

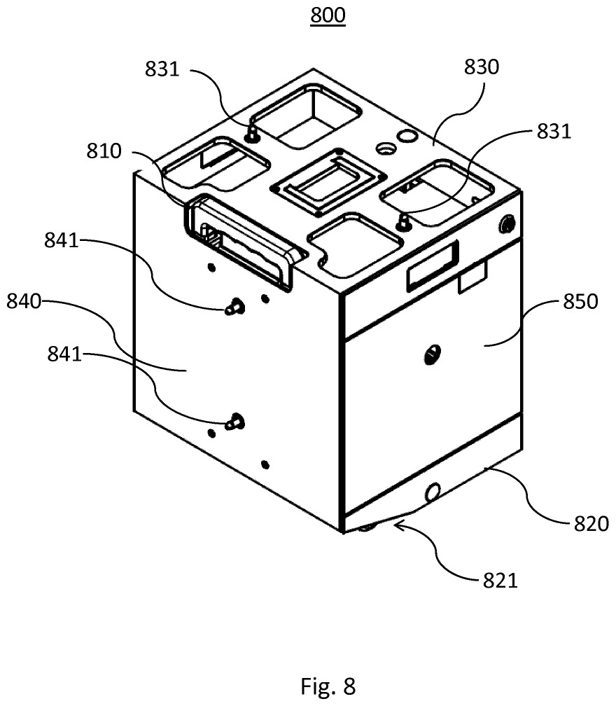

With the guide handle 300, the storage device 1000 can be grasped by a user similar to a suitcase and guided with the wheels 200. The user can therefore move the storage device 1000 via the guide handle 300 without having to bend down or stretch out his arm. The guide handle 300 can be retracted and extended. According to the embodiment shown in FIG. 2, the guide handle 300 is located on one side surface of the storage device. Alternatively or additionally, a guide handle can be located flush with the side surface of the storage device, as illustrated in FIG. 8.

The storage device can have a footprint of 0.1 square meter to 2 square meters. A height of the storage device 1000 can be between 10 centimeters and 2.5 meters, or can be between 0.5 meters and 2 meters.

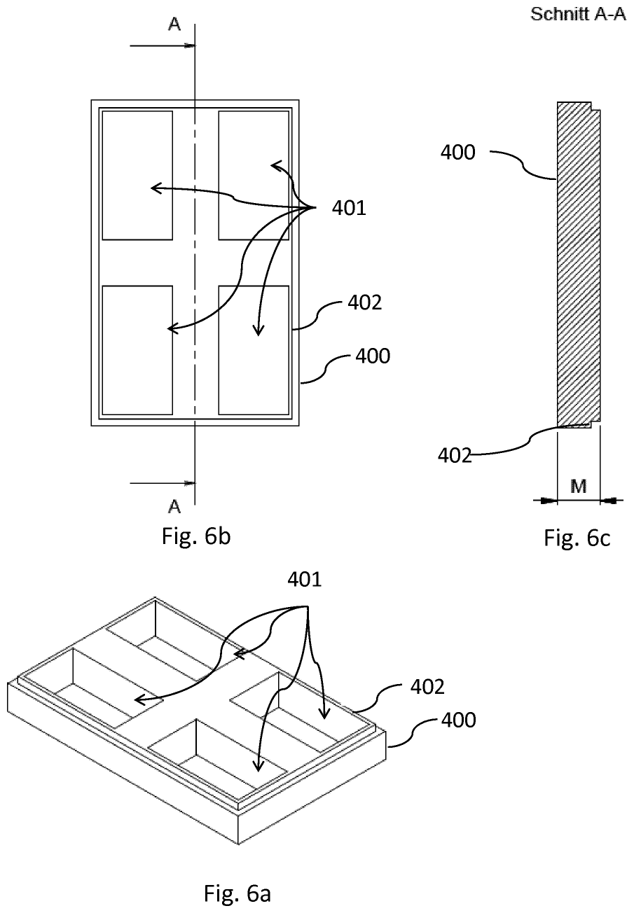

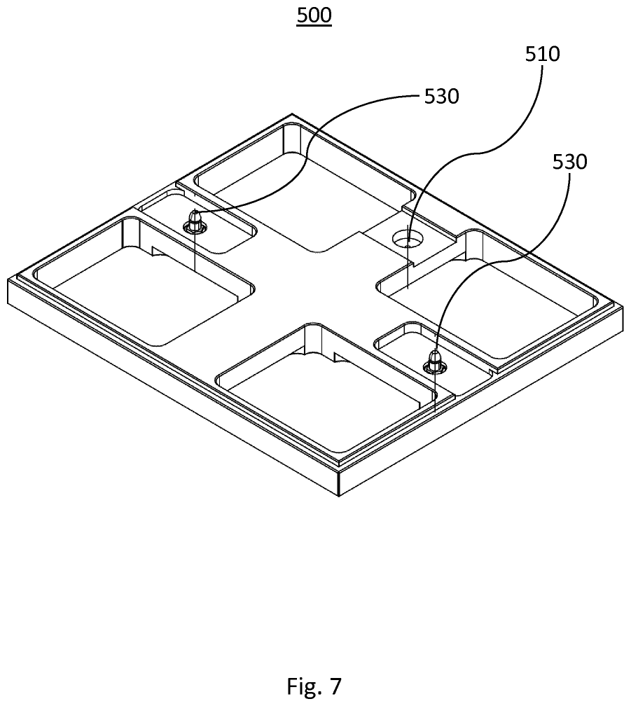

FIGS. 6a to 6c show a base for the storage device according to an embodiment. FIG. 6a is a perspective view of the base. FIG. 6b is a plan view of the upper side of the base and FIG. 6c is a sectional view of the base along line A-A in FIG. 6b. The base can also be indicated as base plate.

The base 400 has essentially the same footprint as the lower side 100e of the housing 100 of the storage device 1000 and is also cuboid in shape. On an upper side of the base 400, the base 400 has a peripheral rim 402 which interacts with a corresponding rim or depression on or in the lower side 100e of the housing when the storage device 1000 is placed on the base 400. In addition, the base has corresponding recesses 401 on the wheels 200 of the storage device 1000 into which the wheels 200 are inserted when the storage device 1000 is placed. A depth of the recess 401 is greater than the total height of a wheel 200 or the length by which the wheels 200 protrude from the housing 100. Thereby the wheels 200 do not touch the bottom of the recess 401 when the storage device 1000 is placed on the base. This prevents unintentional rolling or movement of the storage device 1000. The rim 401 further prevents the storage device 1000 from moving horizontally. The base 400 can also have corresponding positioning elements 100 or locking elements 130 and/or first openings or second openings.

The base can, for example, be screwed to the trunk floor of a vehicle or attached to the trunk floor by means of a Velcro fastener. In this case, Velcro strips (not shown) are attached both to the lower side of the base and corresponding Velcro strips to the trunk floor.

FIG. 7 shows a different embodiment of the base 500. The base shown in FIG. 7 is identical to the base 400 shown in FIG. 6, except for a magnet 510 and positioning elements 530.

More precisely, the base 500 has positioning elements, e.g. two positioning elements 530. The positioning elements 530 correspond to the positioning elements of the storage device and are inserted into the corresponding first openings of the respective storage device when a storage device is placed on the base 500.

The base 500 also has a magnet 510 on a side facing the storage device. The magnet 510 is designed to interact with a magnet attached to the attached storage device or to interact with the housing of the attached storage device if the housing is ferromagnetic. In other words, the magnet has the function of pressing the storage device against the base by means of a magnetic pull. The magnet 510 thus supports the function of the positioning elements 530, which interact with a locking device of the attached storage device. In this way it is possible, for example, to prevent the attached storage device on the base 500 from wobbling. When removing the storage device from the base 500, the user must apply a force, for example a pulling force, to the storage device against the magnetic pull of the magnet 510 in order to release the storage device from the base 500.

FIG. 8 shows a locking device according to another embodiment. The locking device 800 shown in FIG. 8 has a guide handle 810 on one side surface of the storage device. The guide handle 810 is essentially flush with the side surface 840 and is completely recessed in the upper side 830 of the storage device in the retracted state shown. As described with reference to FIG. 2, the guide handle can be pulled out of the upper side 830 of the storage device and the storage device can then be moved or guided by a user via the guide handle 810.

The storage device 800 can be tilted by the user towards the side surface 840 with the guide handle 810. To facilitate tilting, and to prevent the corners or edges of the storage device 800 from touching the floor when tilted, the storage device 800 can have a bevel 821 at one end of its lower side 820, which is connected to the side surface 840 with the guide handle 810. This makes it easier to pull the storage device 800 on just two wheels. According to an embodiment not shown, the storage device may have an additional or alternative rounding.

The storage device 800 according to the embodiment shown in FIG. 8 has two positioning elements 831 located on the upper side 830 and has two locking elements 841 located on the side surface 840. The positioning elements 831 are located one behind the other in a direction perpendicular to the front face 850 of the storage device 800. The locking elements 841 are located one above the other in a direction perpendicular to the upper side 830 of the storage device 800.

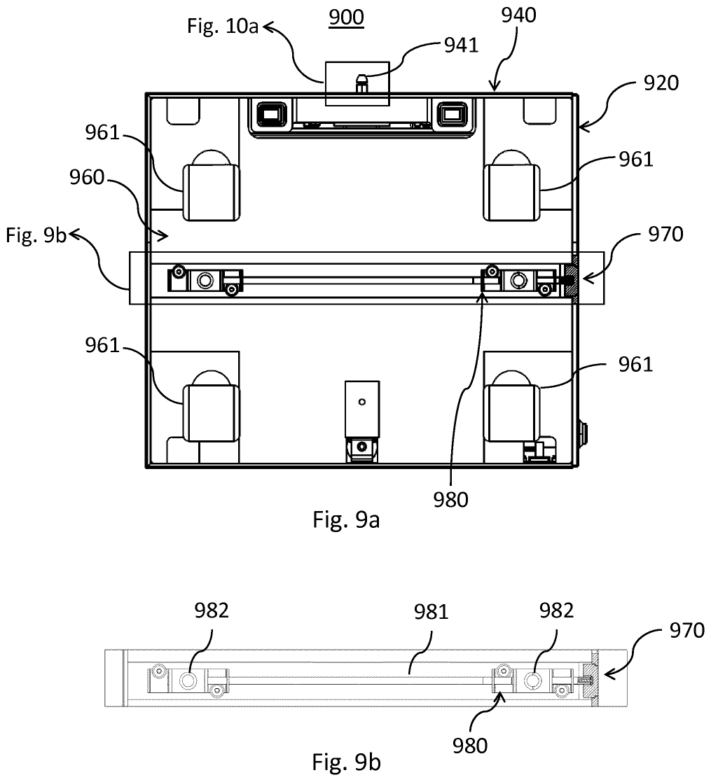

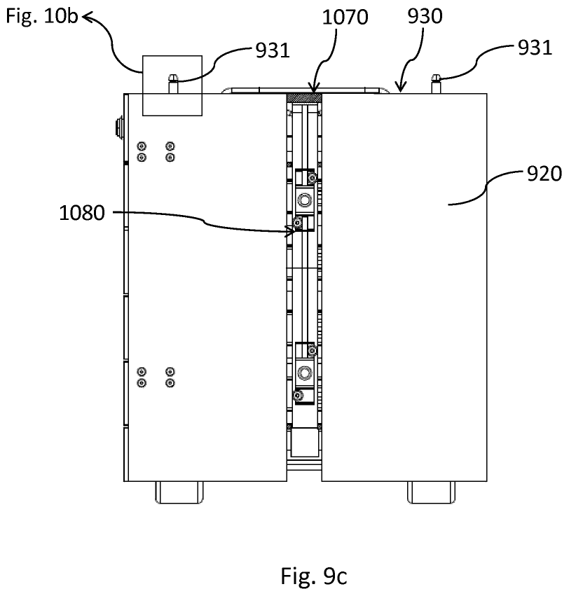

FIGS. 9a to 9c show a storage device according to another embodiment. FIG. 9a shows the storage device 900 from a lower side 960. The lower side has four wheels 961.

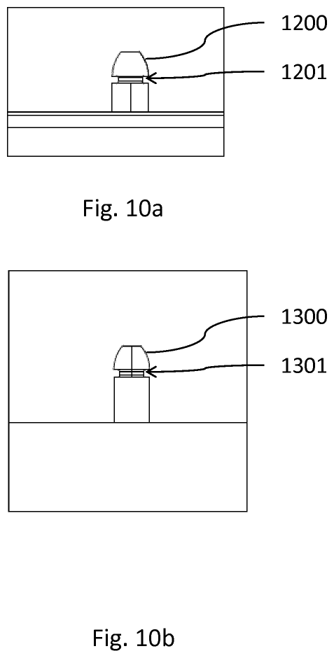

FIG. 9a further shows a locking element 941, which is located on a side surface 940 of the storage device 900. The locking element 941 is shown in detail in FIG. 10a and described further below. In FIG. 9a an unlocking device 970 and a locking device 980 are also shown according to an embodiment. The unlocking device 970 and the locking device 980 are shown in detail in FIG. 9b.

The lower side 960 of the storage device 900 has a rim 962 with a circumferential step. The storage device 900 is designed to be fitted on top of another storage device (not shown), as shown for example with reference to FIGS. 5a to 5c. The step is adapted to receive an edge of an upper side of another storage device in a state where the storage device 900 is placed on the other storage device. A form fit is generated between the two storage devices in a horizontal direction.

As shown in detail in FIG. 9b, the unlocking device 970 is located on an outside, more precisely on a side surface (front side) of the storage device 900 and is designed as a push button.

The locking device 980 has a linkage 981, for example a metal rod. The linkage 981 is firmly connected to the push button of the unlocking device 970. The linkage 981 has two boreholes or holes 982 which are designed to receive the positioning elements of the other storage device in the state in which the storage device 900 is placed on the other storage device. The positioning elements may, for example, be in the form of pins or lugs with a groove formed at least partially in the circumferential direction, as exemplary illustrated in FIG. 10b.

Behind each of the boreholes 982 of the linkage 981 there is a first opening (not shown) on a lower side of the storage device 900 to receive one positioning element each.

A spring (not shown) presses the linkage 981 and the push button with its spring force in horizontal direction, more precisely in the direction of the side surface 920 where the push button is located.

At the same time as the one storage device is placed on the other storage device and the positioning element(s) are inserted into the first opening and the boreholes 982 of the linkage 981, the spring presses the linkage into the groove of the respective positioning elements. This results in a further form fit in the vertical direction with the cooperation of the first openings, the respective positioning element, the groove of the positioning element and the borehole 982 of the linkage, which prevents one storage device 900 from being removed from the other storage device or from falling down due to vibrations etc.

In other words, since the linkage 981 is pressed by the spring into the groove of at least one or more positioning elements of the other storage device, the positioning element(s) are prevented from moving out of the boreholes and the first openings. This, in turn, prevents the two storage devices from moving apart. The two storage devices are thus locked together.

The two storage devices are thus locked together by two form fits or the top mounted storage device is attached to the bottom mounted storage device.

Due to the spring, the two storage devices are automatically locked in place when one storage device is placed on the upper side of the other storage device, as the linkage 981 is automatically pressed into the groove of the positioning element by the spring force without any user intervention.

In order to release the lock and remove the storage devices from each other, a user presses the push button of one storage device 900, which is placed on the other storage device. This exerts a push force from the push-button on the linkage 981. The user's push force overcomes the force of the spring that presses the linkage 981 into the groove of the positioning element. The form fit described above, which acts in a vertical direction, is thereby removed. The user therefore lifts one storage device from the other storage device while simultaneously pressing the pushbutton in order to separate them.

FIG. 9c shows a side view of the storage device 900 with a part of the side wall 920 removed, to enable a view on the locking device 1080 and unlocking device 1070 for locking and unlocking the locking elements of another storage device (not shown) located laterally to the storage device 900.

FIG. 9c also shows positioning elements 931 on an upper side 930 of the storage device 900, which are shown in detail in FIG. 10a.

The locking device 1080 and unlocking device 1070 for locking and unlocking the locking elements of another adjacent storage device act in the same way as the locking device 980 and unlocking device 970 shown in FIG. 9a for placing one storage device and the other storage device next to each other according to the embodiments described above.

FIG. 10a shows a locking element 1200 with a circumferential groove 1201 according to an embodiment. FIG. 10b shows a positioning element 1300 with a circumferential groove 1301 according to an embodiment, wherein the length of the locking element 1200 or positioning element 1300 as well as the width of the respective grooves can be different.

1. Storage device (1000), comprising:
a cuboid housing (100) with an inner space (101), comprising:
a front side (100a) for inserting and removing objects into and out of the inner space (101), and
at least one first opening on one side of the storage device for receiving a respective positioning element (110), wherein in a state in which the positioning element (110) is inserted into the first opening movement of the housing (100) relative to the positioning element (110) is prevented;
at least a second opening on another side of the storage device for receiving a locking element (130),
wherein the storage device (1000) further comprises:
a locking device for locking the storage device (1000) on the locking element (130) in a state in which the locking element (130) is inserted into the second opening and/or for locking the storage device (1000) on the positioning element (110) in a state, in which the positioning element (110) is inserted into the first opening, and
an unlocking device (150) on an outside of the housing (100) for releasing the housing (100) from the locking element (130) and/or from the positioning element (110).

2. Storage device (1000) according to claim 1, further comprising:
at least one locking element (130) on a first side wall (100b) of the housing (100),
wherein the at least one locking element (130) protrudes from the housing (100) and being located at a position which corresponds to the position of a second opening at the second side (100c) of the storage device being opposite to the first side wall (100b), so that in a state in which the at least one locking element (130) of a first storage device (1000a) is inserted into the second opening of a second storage device (1000b), the two storage devices (1000a, 1000b) are located directly next to each other.

3. Storage device (1000) according to claim 1, further comprising:
at least one positioning element (110) on an upper side (100d) or lower side of the housing (100), wherein the at least one positioning element (110) protrudes from the housing (100) and is located at a position which corresponds to the position of a first opening at one opposite side (100e) of the upper side (100d) or lower side of the storage device, so that in a state in which the at least one positioning element (110) of a second storage device (1000b) is inserted into the first opening of a third storage device (1000c), the third storage device (1000c) is directly located on or below the second storage device (1000b).

4. Storage device (1000) according to claim 1, wherein the locking element (130) and/or the positioning element (110) for locking comprises a recess or a projection interacting with the locking device.

5. Storage device according to claim 1,
wherein the locking device comprises a first locking device and/or a second locking device, and
wherein the unlocking device comprises a first unlocking device and/or a second locking device.

6. Storage device according to claim 1,
wherein the first locking device and the first unlocking device are mechanically coupled, and/or
wherein the second locking device and the second unlocking device are mechanically coupled.

7. Storage device according to claim 1, wherein the first unlocking device is configured to drive the first locking device when actuated, so that the first locking device releases the positioning element (110), and/or
wherein the first locking device automatically locking the positioning element (110) into the first opening when the positioning element (110) is inserted into the first opening, so that the positioning element (110) is blocked in the first opening.

8. Storage device (1000) according to claim 1,
wherein the second locking device upon insertion of the locking element (130) into the second opening, automatically locks the locking element (130) in the second opening so that the locking element (130) is blocked in the second opening, and/or
wherein the second unlocking device (150) is configured to drive the second locking device when actuated, so that the second locking device releases the locking element (130).

9. Storage device according to claim 1, wherein the first unlocking device has a push button, and wherein the first unlocking device is configured to cause the first locking device to release the positioning element (110) by pressing the push button.

10. Storage device according to claim 1, wherein the second unlocking device has a push button, and wherein the second unlocking device is configured to cause the second locking device to release the locking element (130) by pressing the push button.

11. Storage device according to claim 1, wherein the first unlocking device is located on a different side of the storage device than the side on which the at least one first opening is located, and/or
wherein the second unlocking device is located on a different side of the storage device than the side on which the second opening is located.

12. Storage device (1000) according to claim 1, wherein the first unlocking device is formed on a front side and/or a rear side of the storage device.

13. Storage device according to claim 1, wherein the second unlocking device is located on an upper side and/or a lower side of the storage device.

14. Storage device (1000) according to claim 1, wherein the at least one positioning element (110) and/or the at least one locking element (130) is embodied as a bolt, pin, or hook.

15. Storage device (1000) according to claim 1, wherein the at least one positioning element (110) and/or the at least one locking element (130) is immersible in the housing (100), preferably by pressure.

16. Storage device (1000) according to claim 1, wherein the at least one positioning element (110) and/or at least one locking element (130) is brought into the state, by means of a release device from the state in which the positioning element (110) and/or the locking element (130) is sunk in the housing, in which the positioning element (110) and/or the locking element (130) protrudes from the housing (100), wherein the release device being located in or on the housing (100).

17. Storage system with at least two storage devices (1000a, 1000b) according to claim 1, wherein in an assembled state of the storage system at least two storage devices (1000a, 1000b) are located such that at least one of the locking elements (130) of a first storage device (1000a, 1000b) of the two storage devices (1000a, 1000b) is inserted and blocked in the corresponding second opening of a second storage device (1000a, 1000b) of the two storage devices (1000a, 1000b), so that the at least two storage devices (1000a, 1000b) are locked together.

18. Storage system with a storage device according to claim 1 and a base (500) with at least one positioning element (530), wherein in a state in which the storage device is placed on the base, at least one positioning element (530) is inserted and blocked in the corresponding first opening of the storage device, so that the storage device is locked on the base (50).
